(19) United States
(12) Patent Application Publication
(10) Pub. No.: US 2014/0012771 A1
(43) Pub. Date: Jan. 9, 2014

(54) Method of Operating a Digital Exchange Serving as an Integrated, Continuous Sponsorship and Promotion System

(71) Applicants: William R. Dunbar, Oconomowoc, WI (US); Matthew Dennis Serpe, Kenosha, WI (US)

(72) Inventors: William R. Dunbar, Oconomowoc, WI (US); Matthew Dennis Serpe, Kenosha, WI (US)

(73) Assignee: VIGEOMEDIA, LLC, Kenosha, WI (US)

(21) Appl. No.: 13/933,974

(22) Filed: Jul. 2, 2013

Related U.S. Application Data
(60) Provisional application No. 61/667,551, filed on Jul. 3, 2012.
(60) Provisional application No. 61/681,838, filed on Aug. 10, 2012.

(51) Int. Cl. G06Q 30/02

(52) U.S. Cl. CPC G06Q 30/0279
USPC 705/329

(57) ABSTRACT

A method of operating a sponsorship exchange system to connect sponsors with organizations or individuals within a community for the guided sponsorship from sponsors of organizations or individuals linked to a digital media network. A related method includes providing a system that includes a networked electronic forum for the submission and display of a sponsorship proposal, receiving and processing an electronic communication from a community organization or individual, where the communication indicates acceptance of the sponsorship proposal. Sponsors may be automatically awarded advertising as sponsorship proposals reach predetermined support levels. The method also includes automatically sending an electronic communication with information regarding the acceptance of the sponsorship proposal by the community organization or individual. Further, the method includes receiving an electronic communication that include information demonstrating compliance with terms of the sponsorship proposal, and crediting the community organization for each communication demonstrating compliance with terms of the sponsorship proposal.

### CROSS-REFERENCE TO RELATED PATENT APPLICATIONS

This patent application claims the benefit of U.S. Provisional Patent Application Nos. 61/667,551, filed Jul. 3, 2012, and 61/681,838, filed Aug. 10, 2012, the entire teachings and disclosure of which are incorporated herein by reference thereto.

### FIELD OF THE INVENTION

This invention generally relates to systems and methods for tracking, advising and promoting business and organization activities within a community in a continuous integrated sponsorship marketplace and media network.

### BACKGROUND OF THE INVENTION

In many cases, community organizations, such as youth sports leagues, church groups, and social organizations, rely on sponsorships by local sponsors, for example, to fund ongoing operations. Thus, fundraising becomes an important function of the community organization. At the same time these sponsors rely on the purchasing power of the organization's members and associates. Thus the digital exchange provides a system and method for sponsorship communications, proposals, acceptance between the sponsors, community organizations and complying members and associates with measurable rewards.

To the extent possible, it may be advantageous for community organizations to utilize various media outlets to aid in their fundraising activities. However, for many community organizations, the access cost may be a barrier to certain types of media. Typically, news and information flow to a media outlet via paper transfers, voicemails and telephone conversations, electronically through email systems, electronically through established media interfaces, such as facsimile, and/or via field reporters. In most cases, the news and information input is accomplished manually in the sense that an action must be taken beyond the normal operation of the news event in order to input news to the local media company.

Embodiments of the invention provide a system and method to facilitate sponsorship of community organizations that can be integrated with communications information and news flow networks. These and other advantages of the invention, as well as additional inventive features, will be apparent from the description of the invention provided herein.

### BRIEF SUMMARY OF THE INVENTION

Embodiments of the present invention include a digital exchange system that advantageously addresses the issue of how sponsors and organizations can utilize their sponsorship activities within a community to cost-effectively create visibility for their organization, and how sponsors and organizations can automatically be positioned to receive recognition across an integrated digital media network in a continuous sponsorship environment. One such digital media network is described in U.S. Patent Publication No. 2009/0172076, filed on Dec. 31, 2007, the entire teaching and disclosure of which in incorporated herein by reference thereto.

Embodiments of the present invention include a method that involves allocating a predetermined portion of proceeds flowing from a sponsorship. Further, sponsors and/or other organizations could be rewarded with recognition within the integrated media network they are supporting when their sponsorship reaches a predetermined threshold amount. These sponsors and organizations would be able to view, accept, or initiate sponsorship proposals directed at specific or any organization or participant registered on the digital proposal exchange.

In one aspect, embodiments of the invention provide a method of electronically facilitating sponsorship of community organizations. As used herein, the term “community organization” also refers to schools and similar educational and teaching organizations as well as to local or regional sports organizations or other such groups that have a common interest, goal or activity. The method includes providing a system that includes a networked electronic forum for the submission of a sponsorship proposal, and receiving and processing an electronic communication from a member of a community organization, where the communication indicates acceptance of the sponsorship proposal. The method also includes automatically sending an electronic communication with information regarding the acceptance of the sponsorship proposal by the community organization or sponsor. Further, the method includes receiving an electronic communication that includes information demonstrating compliance with terms of the sponsorship proposal, and crediting the community organization for each communication demonstrating compliance with terms of the sponsorship proposal.

In a further embodiment, electronic communications are sent and received via the internet. More particular embodiments of the method include configuring the system to send and receive electronic communications via a mobile communications device. The mobile communications device may be a tablet computer or a smart phone.

Certain embodiments of the method include maintaining a database that stores contact information of members and associates of the community organization. The method may also include automatically sending electronic communications to members and associates of the community organization regarding the acceptance of the sponsorship proposal by the community organization, where the electronic communications further specify terms of compliance for the sponsorship proposal. Further, the method may include configuring the system to allow members and associates to send electronic communications to third parties regarding the acceptance of the sponsorship proposal by the community organization.

In a particular embodiment of the invention, the method further includes generating an identification code, where the identification could be a QR code, a barcode, or an identification number. In more particular embodiments, receiving electronic communications that have information demonstrating compliance with terms of the sponsorship proposal includes receiving electronic communications with the identification code number. Further, the identification code may be uploaded to the digital exchange by the sponsor.

In certain embodiments, crediting the community organization for each communication demonstrating compliance with terms of the sponsorship proposal includes awarding a number of points (or alternatively a percentage of the purchase price, or a fixed amount per purchase) to the community organization for each communication demonstrating compliance with terms of the sponsorship proposal, where each point awarded has a monetary value. Additionally, the server may be further programmed to randomly award prizes to system users who demonstrate compliance with terms of the sponsorship proposal.

In another aspect, embodiments of the invention provide a system for facilitating sponsorship of community organizations that includes a computer server connected to a communications network. The communications network may be the internet or an intranet. The server is programmed to accept and process a registration submitted over the network by a community organization, to accept and process a sponsorship proposal submitted over the network by a sponsor, and to receive communications indicating acceptance of the sponsorship proposal by the community organization. The server is also programmed to automatically send communications regarding acceptance of the sponsorship proposal to members of the community organization, to receive communications demonstrating compliance with terms of the sponsorship proposal, and to credit the community organization for each communication received demonstrating compliance with terms of the sponsorship proposal.

In a particular embodiment, the server is programmed to generate an identification code for a user of the digital exchange. The aforementioned communications demonstrating compliance with terms of the sponsorship proposal may include the identification code. Further, the server may be programmed to distribute the identification code to a mobile communications device.

In certain embodiments, the server includes a database with contact information for members of the community organization, and may include contact information for associates or affiliates of the community organization. Also, the server can be programmed such that system users can arrange to automatically send electronic communications to third parties regarding acceptance of the sponsorship proposal to members of the community organization.

In yet another aspect, embodiments of the invention provide a method of operating a digital exchange system. The method includes providing a server connected to a communications network configured for two-way communications with system users, and configuring the server to display, on a system user device, information on one or more community organizations or individuals and sponsorship needs thereof. The method further includes accepting, and displaying on the system user device, electronically-submitted sponsorship offer plans from a sponsor for one of the one or more community organizations or individuals, and accepting data regarding the one or more community organizations or individuals, and the sponsor. The data is submitted electronically by system users associated with the sponsor or the one or more community organizations or individuals. The method also includes registering one or more participants desiring to participate in the sponsorship offer plan, tracking an extent of participation in the sponsorship offer plan by the one or more participants, and allocating proceeds to the one or more community organizations or individuals based on the extent of participation in the sponsorship offer plan by the one or more participants.

In a particular embodiment, the method further includes automatically tracking when a sponsorship reaches a predetermined threshold amount, thereby generating an entry into a database linked to a content management system to position an advertisement for a sponsor in one or more digital media networks. The method may also include tracking and monitoring one or more customer loyalty programs linked to a sponsor, and tracking expenditures under the one or more customer loyalty programs. Certain embodiments of the method include creating a sponsorship profile in which multiple sponsorship offer plans can be run simultaneously. Further embodiments include automatically sending an electronic communication with information regarding the acceptance of the sponsorship proposal by the community organization or individual.

In a further embodiment, the method includes creating a needs profile for the community organization or individual, wherein the needs profile includes one or more funding needs of the community organization or individual, and linking the participant to one of the one or more funding needs, such that the participant's participation in the sponsorship offer plan results in the allocation of proceeds to the one of the one or more funding needs. The needs profile may include a primary need that identifies a funding need of the community organization, a secondary need that identifies a funding need of a subgroup within the community organization, and a tertiary need that identifies a funding need of a subset of the subgroup within the community organization. The method may also include creating an identification code to link the participant to the primary need, secondary need, tertiary need, or any combination thereof, and automatically allocating the proceeds of a purchase by the participant among the primary need, secondary need, tertiary need, or any combination thereof.

In certain embodiments of the invention, configuring the server to display information on one or more community organizations or individuals and the sponsorship needs thereof includes accepting data by system users regarding the sponsorship needs and goals of the individual, community organization or subgroup thereof, to create a sponsorship needs plan for one or more of the funding needs of the individual, community organization or subgroup thereof, displaying, on the system user device, specific sponsorship goals for the community organization or individual, and automatically tracking a level of performance for the sponsorship offer plan based on the extent of participation in the sponsorship offer plan by the one or more participants. This embodiment also includes automatically tracking a level of performance for the sponsorship needs plan based on the extent of participation in the sponsorship offer plans by the participants, and displaying, on the system user device, projections to reach sponsorship objectives, and automatically generating and electronically sending a recommendation for at least one action to achieve the established sponsorship goal. In a further embodiment, a system user submits data regarding the desired objectives of a sponsor to create a sponsor objectives plan.

In certain embodiments, tracking an extent of participation in the sponsorship offer plan by the one or more participants includes tracking purchases from the sponsor made by the one or more participants under the sponsorship offer plan. In a particular embodiment, allocating proceeds to the one or more community organizations or individuals based on the extent of participation in the sponsorship offer plan by the one or more participants includes allocating a percentage of each purchase made by the one or more participants under the sponsorship offer plan. The method may include integrating the digital exchange system with a digital media network such that the digital media network automatically generates media content using information gathered from the digital exchange system. Additional embodiments include requesting and tracking user-generated media content submittals from crowd-sourced reporters. Furthermore, the method may include providing the one or more participants a subscription to media content on the digital media network. Other embodiments include disseminating information regarding the sponsorship offer plan via the digital media network. In some embodiments, disseminating information regarding the sponsorship offer plan via the digital media network comprises automatically generating promotions or advertisements for placement into digital media content available via the digital media network.

In a further embodiment, the method includes integrating the digital exchange system with a digital media network that contains digital media networks, configured to provide electronic magazines, websites, and mobile applications, whereby participants are provided subscriptions or subscribe to such digital media networks, or pre-subscribe to potential digital media networks, where the subscriptions are linked to the digital exchange system. Linking subscriptions to the digital exchange system may include automatically generating media content to be published on the digital media network using information gathered from the digital exchange system. Additionally, the method may include automatically tracking and monitoring a number of subscriptions and an amount of allocated proceeds generated through the digital exchange system by participants who subscribe to the digital media network, in order to determine an extent of production for the digital media network. In particular embodiment, the method calls for automatically alerting subscribers, and automatically requesting and tracking user-generated media content submittals from participants for use in one or more of the digital media networks, and also disseminating information regarding the sponsorship offer plan via the digital media network.

In particular embodiments of the invention, the method requires receiving information from a point-of-sale (POS) system or mobile application provided by the sponsor, and allocating funds to the one or more community organizations or individuals and then to various needs and programs at different levels based on the information received from the POS system or mobile application. In a particular embodiment, allocating funds to community organizations or individuals based on the information received from the POS system or mobile application includes allocating funds to the one or more individuals or community organizations, or to particular programs within those one or more community organizations without additional input from the participant. In a more particular embodiment, allocating funds to community organizations or individuals without any additional input from the participant includes allocating funds to community organizations or individuals and then to various specified programs and needs within those organizations and schools based on previously-made default selections by the participant. In a further embodiment, receiving information from the point-of-sale (POS) system or mobile application includes electronically receiving information from a point-of-sale (POS) system or mobile application that is automatically or manually entered into the POS or mobile application. In at least one embodiment, electronically receiving information from a point-of-sale (POS) system or mobile application includes receiving participant identification information from a point-of-sale (POS) system or mobile application.

The aforementioned method may include configuring the digital exchange system such that any of the one or more community organizations or individuals can specify a plurality of needs such that each of the plurality of needs may be linked with a different sponsorship offer plan. In some embodiments, the one or more participants can choose to be associated with any sponsorship offer plan or with any of the plurality of needs. In some cases, the association between the one or more participants and the sponsorship offer plan is provided via an identification card for the one or more participants. The method may also include automatically notifying individuals, community organization members, and sponsors of the acceptance of a specific sponsorship proposal. Other embodiments require providing a means to electronically send a request to participate in a specific sponsorship initiative to potential sponsors.

In an embodiment of the invention, the method includes automatically matching sponsors with community organizations or individuals based on needs of the community organization or individual, and objectives of the sponsor, determined from stored information on the community organization or individual, a sponsorship needs plans and sponsorship offer plans, and automatically notifying the community organization or individual and sponsor of the automatic matching. The method may further require generating a user identification code for each of the one or more participants. Some embodiments include generating a profile that include past purchasing behavior for one of the one or more participants so that certain participants may be targeted with specific sponsorship offer plans of interest to that participant.

The method may also include allocating a variable percentage, or fixed percentage, of each purchase made by the participant under the sponsorship offer plan. Alternatively, the method may include allocating points awarded to the participant based on a level of participation in the sponsorship offer plan. This type of allocation may involve varying the percentage of each purchase based on the requirements of the sponsorship offer plan. In particular embodiments, the sponsorship offer plan may vary the allocation percentage based on one the time of day the purchase is made, the day of the week the purchase is made, and the month of the year the purchase is made. In other embodiments, the sponsorship offer plan varies the allocation percentage based on the level of participation in the sponsorship offer plan. In some embodiments, the method includes creating a sponsorship proposal exchange configured to electronically receive and transmit sponsorship proposals between community organizations or individuals, sponsors and participants, and further configured to electronically receive and transmit an acceptance of terms in one of the one or more sponsorship proposals.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a block diagram that shows a digital exchange system and its interaction with sponsors, community organizations or individuals, and participants, according to an embodiment of the present invention;

FIG. 2 is a block diagram illustrating various components of the digital exchange system, according to an embodiment of the invention; and

FIG. 3 is a block diagram illustrating a digital media network constructed in accordance with an embodiment of the invention.

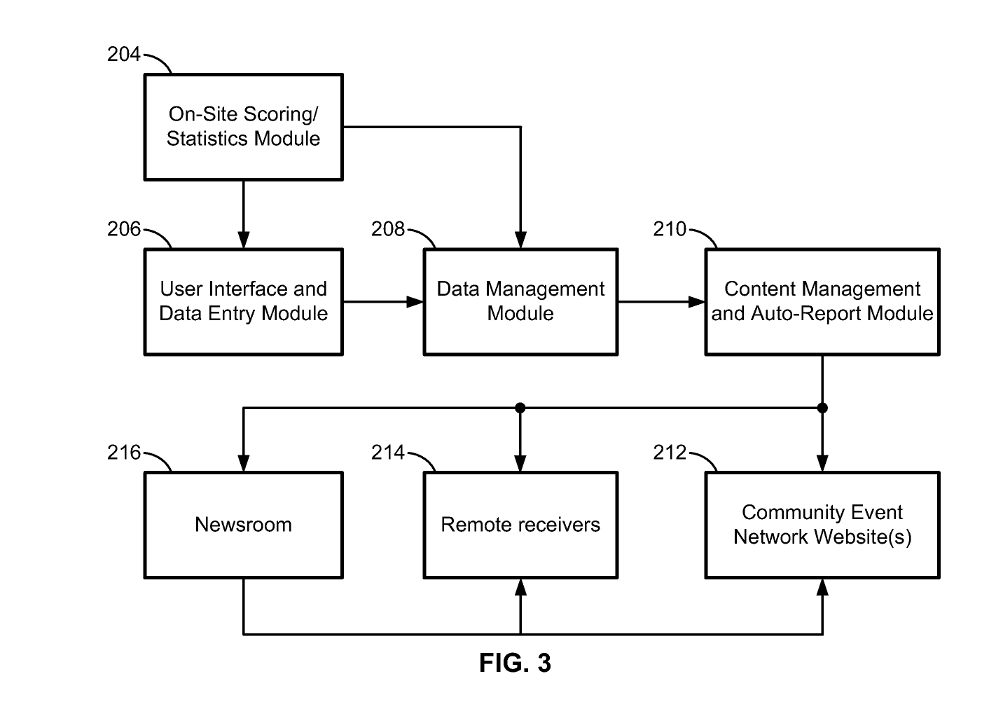

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

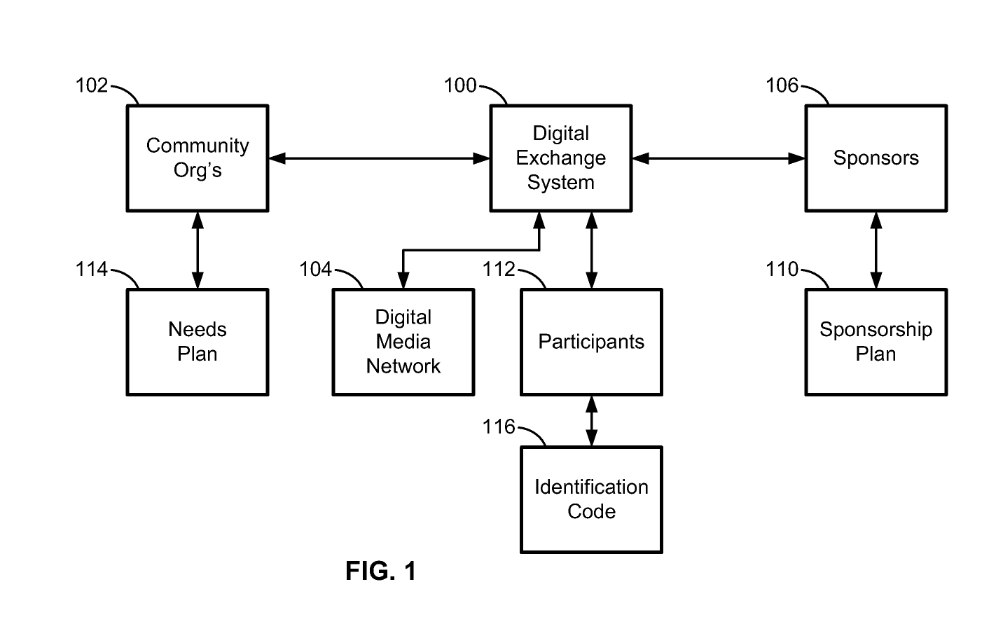

As shown in FIG. 1, embodiments of the present invention provide a digital exchange system 100 to track the support and sponsorship of community organizations 102 for the purpose of directing resources to assist the sponsorship needs while assigning recognition within an integrated digital media network 104. Further, embodiments of the invention permit community organizations 102 to create arrangements with sponsors 106 for continuous sponsorship, and to provide an automated and quantifiable method for resource allocation and recognition.

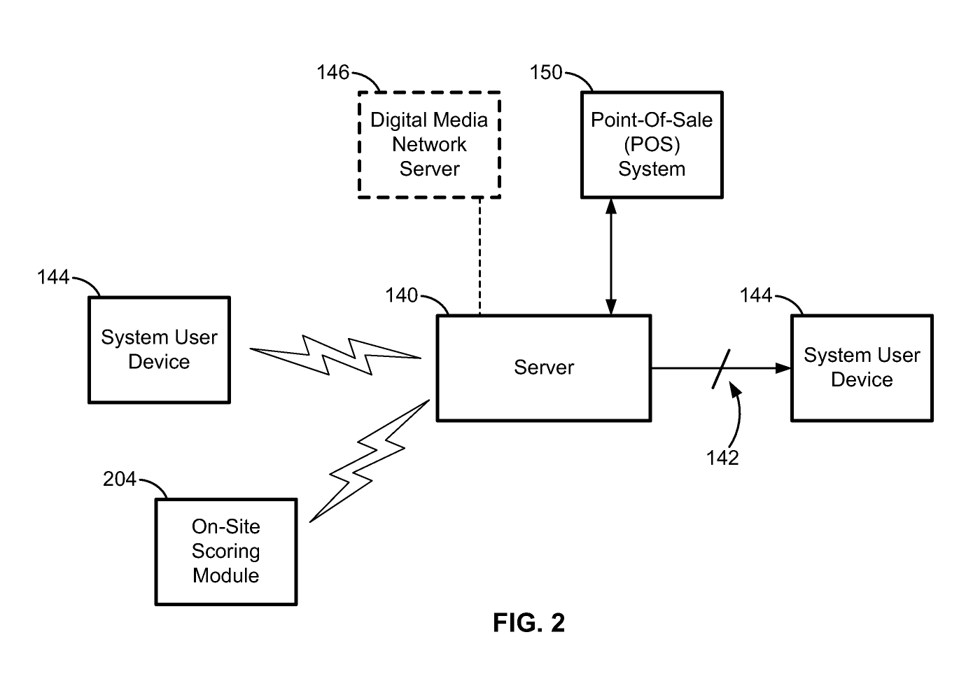

In at least one embodiment, a digital exchange system 100 for facilitating sponsorship of community organizations 102 includes a server 140 (see FIG. 2) connected to a network 142 (see FIG. 2), such as the internet, an intranet, cellular and/or Wi-Fi network, and programmed to provide for the electronic dissemination of community-based information, and programmed to provide a digital exchange system 100 to facilitate the sponsorship of community organizations 102 by sponsors 106 and participants 112.

FIG. 2 is a schematic block diagram that illustrates the server 140, network 142, and system user devices 144, according to an embodiment of the invention. System user devices 144 include, for example, personal computers connected to the internet or an intranet, mobile wireless devices such as smartphones or tablets. These system user devices 144 may be employed by members of the community organization 102, by the sponsor 106 and its employees, agents or affiliates, participants 112 in the sponsorship offer plan, also referred to as sponsorship plan 110, crowd-sourced reporters, etc. The server 140 may also be configured to wirelessly communicate with on-site scoring modules 204, which are discussed in more detail below. The primary elements of the digital media network 104 may reside on server 140, or optionally may reside on a digital media network server 146 (shown in phantom) in communication with server 140.

Embodiments of the present invention include a system and method which provide community organizations 102 and sponsors 106 an integrated, automated system that serves to match the needs of the organizations 102 (and the people therein) with the objectives of the sponsors 106 within a community and/or region.

In particular embodiments of the invention, community organizations 102 connect to the digital exchange network 100 in three primary ways:

1. A connection between the server 140 and system user from the community organization 102 that allows the system user to register and electronically submit a needs plan 114 that describes the needs of the community organization 102—and then based on that needs plan 114, receive automated reports generated by the system that assist the community organization 102 with visibility and sponsorship. Demographic, contact, and descriptive information may be provided by the community organization 102 as a part of a community organization profile. Details regarding desired sponsorship are provided as a part of the needs plan 114.
2. Use of the aforementioned connection that allows the system user to submit content about their activities and accomplishments for publishing on the digital media networks 104.
3. Connection to the digital exchange system 100 to:
Receive proposals from the sponsors 106;
Offer proposals to the sponsors 106; and
Participate in sponsorship plan 110 that results from purchases by the sponsorship plan participants 112.

The diagram of FIG. 1 also shows how sponsors 106 interface with connect to the network 142 in three ways:

1. A sponsor 106 may join the digital exchange system 100 by electronically submitting registration information via the digital exchange system 100. In a particular embodiment, as an integral part of the sponsor registration, the sponsor 106 develops (and maintains thereafter) the sponsorship plan 110 and a sponsor objectives plan by filling out a template of information about the sponsor 104. For example, a restaurant may have an objective to increase business on a certain day of the week, and construct a sponsorship plan 110 that corresponds to that objective. Demographic, contact, and descriptive information may be provided by the sponsor 106 as a part of a sponsor profile.
2. Connection to the digital exchange system 100 to:
Receive proposals from community organizations 102;
Offer proposals to the community organizations 102;
Receive communications and recommendations from the digital exchange system 100 regarding various proposals;
   3. Connection to the digital exchange system 100, which is attached to the digital media networks 104, and wherein the digital exchange system 100 may be configured to automatically place various types of promotions and/or advertisements that roll into one or more digital media networks 104.

Participants 112, whether individuals or some other type of entity, may also be asked to register and to provide information which could be used to construct a participant profile. Part of the registration process may involve issuance of a unique identification code 116 for the participant.

In any community, there may be events which could affect sponsorship levels, or which could be used to affect sponsorship levels. To take advantage of these instances, community organizations 102 and sponsors 106 may disseminate information regarding the event and/or the sponsorship via the digital media network 104. In some cases, information may be efficiently disseminated by crowd-sourced reporting in which spectators or members of the general public provide facts, reporting, video, etc. to communicate the desired message. The digital media network 104 may be configured to electronically send out alerts soliciting crowd-sourced reporting, and further configured to process the information provided by such crowd-sourced reporting.

The digital exchange system 100 may also be configured to track one or more customer loyalty programs implemented by a particular sponsor 106, and allocate funds to the community organization 102 and awards to the participants 112 in accordance with the requirements of the customer loyalty program. Under some customer loyalty programs, customers may fall into any one of several program categories (e.g., platinum, gold, silver, etc.) which identify the status of the customer. The sponsor 106 may base certain allocations on a participant's status under the customer loyalty program. The digital exchange system 100 may be further configured to generate reports showing, for example, purchase history of participants 112, affiliations, interests, etc. In some embodiments, the digital exchange system 100 is configured to automatically notify participants 112 and sponsors 106 when the participant 112 is eligible for an award under the customer loyalty program. Additionally, it should be noted that, in a particular embodiment of the digital exchange system 110, sponsors 106 are able to offer sponsorship plans 110 allocating money to a community organization 102 that does not require participants 112 to register or to explicitly indicate any support for the community organization or acceptance of the sponsorship plan 110.

In certain embodiments, the on-site scoring/statistics module 204 receives data from crowd-sourced reporters. The module 204 can interface with or be an integral part of hardware devices such as portable electronic scoring devices, scoreboards, etc. to automatically obtain the data. The data can include information relating to a community event, a sporting event, an advertisement, a promotional event and the like. The module 204 interfaces with a user interface and data entry module 206 that sends the data to data management module 208. The user interface and data entry module 206 may also receive data from crowd-sourced reporters. Alternatively, module 204 directly sends data to data management module 208.

Data entered is stored in data management module 208, from which calculations are performed resulting in another level of analytics, such as sporting statistics, purchasing behavior, such as batting averages, earned run averages, team/individual standings, etc. Data management module 208 may include multiple data storage servers located at one or more selected locations. For example, the servers could be stored in a central location or distributed throughout the communities being served.

The content management and auto-report module 210 transforms the data into a format for viewing at community event network website(s) 212 and/or at remote receivers 214 throughout the community and/or region. The auto-report function automatically transforms parts of the data entered into print-ready verbiage for display on/in the various platforms. Print-ready verbiage means the data is in a grammatically correct format that is readable by an end user or ready for additional editing or review at newsroom 216. Newsroom 216 may be a newspaper newsroom, a television news station, news-based website, etc.

In a particular embodiment, the digital exchange system 100 contains an algorithm that monitors the on-going transactions through the system. The digital exchange system 100 tracks, among other things, the following and/or performs the following calculations: monthly purchase amounts input through the system—total from all sponsors in a given community/region, breakdown by business category (categories e.g., as shown in a digital sponsor network), breakdown by business category averages, breakdown by organization, i.e., purchase amounts attributed to each organization, and breakdown by organization on a per user ID card (e.g., $100,000 of purchases were recorded in the exchange system for a specific organization and the organization has 500 ID cards, resulting therefore in an average for this organization of $200/ID card); for each participating sponsor, number of registered users in each community organization or school that have made a purchase in the recent past (e.g., by month, over the last 6 months), comparing that to the total number of registered users in each community organization or school.

In the digital exchange system 100, sponsors 106 may enter the conditions for sponsorship or to enhance sponsorship, such as purchases made on a specific day or time of day. The sponsor 106 may also enter temporary programs or promotions during which time the sponsorship levels increase. The digital exchange system 100 may also be programmed to automatically send electronic notifications to selected participants 112 and community organizations 102.

Referring again to FIG. 2, it can be seen that an embodiment of the invention includes operating the digital exchange system 100 in connection with a point-of-sale (POS) system 150. In particular embodiments, the process is initiated when, for example, a community resident, in this case acting as a participant 112, enters, for example, a retail establishment of a sponsor 106 having a POS system 150 that is capable of linking participant sales to the digital exchange server 140. One way this may be accomplished is by assigning a particular function key or keys that make the association, such that a cashier may press the function key at the beginning, during or at the end of a transaction to indicate that the transaction is to be associated with the digital exchange system 100 (see FIG. 1). In this way, the digital exchange system 100 may be credited with a percentage of the proceeds from each of these sales or a fixed predetermined amount for each sale. Those credited proceeds are then allocated to the appropriate community organization 102 in accordance with the relevant sponsorship plan 110. For example, a participant 112 may be issued an identification (ID) card having the unique identification code 116 referred to above, thus indicating an affiliation with the digital exchange.

In this manner, the POS system 150 can assign and track all sales resulting from those particular sponsorships being initiated by the digital exchange, and provide in a single document, a spreadsheet in a predetermined format for example, the total sales volume for a given period that is associated with the digital exchange. This data may be provided to the operator of the digital exchange system 100 to facilitate the transfer of any funds due the digital exchange. In a particular embodiment, this data is transferred electronically between the POS system 150 of the sponsor 106 and the digital exchange system 100. Such data transfers may occur automatically at predetermined intervals (e.g., weekly or the first day of the month). In alternate embodiments, the data may be transferred electronically between the POS system 150 and the digital exchange system 100 by system operators or automatically.

To effect the subsequent transfer of funds from the digital exchange system 100 to its various community organizations 102, in at least one embodiment of the invention, the participant 112 accesses the digital exchange system 100, via the network using a PC or via a mobile application for example, to enter relevant data concerning any transactions that should be credited to a particular community organization 102. In certain embodiments of the invention, when the participant 112 accesses the digital exchange system 100, the participant 112 is given the option of allowing any proceeds from the participant's recent transaction(s) to flow to one or more previously selected community organizations 102. This may be a default allocation for any proceeds generated for the digital exchange system 100 by the participant 112. In a particular embodiment, this default allocation to one or more community organizations 102 is stored in the digital exchange system 100 until modified or deleted by the participant 112. The participant 112 also has the option to designate one or more other community organizations 102 to receive the proceeds from any transactions being entered into the digital exchange system 100. The proceeds can be divided among one or more community organizations 102 in any percentages specified by the participant 112.

The digital exchange system 100 can be further programmed to periodically (e.g., monthly, weekly, daily, etc.) generate reports regarding purchases made under each sponsorship plan 110 during the period, allocations to community organizations during the period, and invoices to sponsors 106 and/or community organizations for services provided by the digital exchange

However, in alternate embodiments of the invention, when sponsors 106 without a POS system 150, the cashier and/or participant may use a networked personal computer or mobile device such as a tablet or smart phone, or business kiosk with the appropriate application software platform to enter any data for transactions which may be requested by the digital exchange system 100. Furthermore, the sponsor 106 may have a mobile electronic communications device for the entry of information to be transmitted to the digital exchange system 100. In particular embodiments, the mobile electronic communications device may run a mobile application configured to transfer information to the digital exchange system 100 in a specific format or sequence.

For example, if the participant has an ID card and unique identification code 116 associated with the digital exchange system 100, the cashier may scan and/or enter all of the necessary data into the mobile communications device at the time of the sale. Alternatively, data may be entered by the participant, at a designated business kiosk, and may include an ID card with an identification code 116 or some other identifying information, along with the details of the particular transaction with the sponsor 106. In these cases, data can be entered into the kiosk or mobile application in an online or offline fashion. If in offline mode, the data can be transferred electronically subsequently to the digital exchange system 100.

The digital exchange system 100 may be configured to automatically reconcile the data from the participant with that provided from the POS system 150 of the sponsor 106. In certain embodiments, any inconsistencies in the data from the sponsor 106 and participant 112 are flagged by the digital exchange system 100 so that the appropriate corrections can be made.

In an alternate embodiment of the invention, the sponsor 106 may obtain certain information from the participant 112 at the time of sale to allow the digital exchange system 100 to make the allocations without additional input from the participant 112. For example, the cashier may request a phone number or ID card number from the participant 112, and the POS system will record both the digital exchange system 100 and the participant identification code 116 associated with the transaction. Without any additional input from the participant 112, the digital exchange system 100 can use this information provided by the POS system 150 to properly allocate funds to community organizations 102 (and from there to needs, programs and participants 112 within the community organization 102) based on the default selections made by the participant 112.

In this embodiment, the participant 112 may still have the option of accessing the digital exchange system 100 to modify the default allocations, or specify new allocations, for particular transactions. For example, the participant 112 may specify that all proceeds from transactions with one sponsor 106 go to a first community organization 102, while all proceeds from transactions with a second sponsor 106 go to a second community organization 102. Another example, the participant 112 may specify that proceeds from transactions go to multiple community organizations 102, with specified percentage weights.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of operating a digital exchange system, the method comprising:
providing a server connected to a communications network configured for two-way communications with system users;
configuring the server to display, on a system user device, information on one or more community organizations or individuals and sponsorship needs thereof;
accepting, and displaying on the system user device, electronically-submitted sponsorship offer plans from a sponsor for one of the one or more community organizations or individuals;
accepting data regarding the one or more community organizations or individuals and the sponsor, the data submitted electronically by system users associated with the sponsor or the one or more community organizations or individuals;
registering a participant desiring to participate in one or more sponsorship offer plans, wherein said participation establishes an electronic link in the digital exchange system between the participant and the one or more community organizations or individuals;
tracking an extent of participation in the sponsorship offer plan by the participant; and
allocating proceeds to the one or more community organizations or individuals based on the extent of participation in the sponsorship offer plan by the participant.

2. The method of claim 1, further comprising:
creating a needs profile for one of the one or more community organization or individual, wherein the needs profile includes one or more funding needs of that community organization or individual; and
linking the participant to at least one of the one or more funding needs, such that the participant's participation in the sponsorship offer plan results in the allocation of proceeds to at least one of the one or more funding needs.

3. The method of claim 2, wherein the needs profile comprises:
a primary need that identifies a funding need of the community organization;
a secondary need that identifies a funding need of a subgroup within the community organization; and
a tertiary need that identifies a funding need of a subset of the subgroup within the community organization;
wherein the method further comprises creating an identification code to link the participant to the primary need, secondary need, tertiary need, or any combination thereof, and automatically allocating the proceeds of a purchase by the participant among the primary need, secondary need, tertiary need, or any combination thereof.

4. The method of claim 1, wherein configuring the server to display information on one or more community organizations or individuals and the sponsorship needs thereof comprises:
accepting data by system users regarding the sponsorship needs and goals of the individual, community organization or subgroup thereof, to create a sponsorship needs plan for one or more of the funding needs of the individual, community organization or subgroup thereof;
displaying, on the system user device, specific sponsorship goals for the individual, community organization or subgroup thereof;
automatically tracking a level of performance for the sponsorship needs plan based on the extent of participation in the sponsorship offer plans by the participants;
automatically notifying the participant of the progress being made for a particular sponsorship needs plan or sponsorship offer plan; and
displaying, on the system user device, data for an actual extent of participation, actual sponsorship performance versus goals and projections to reach sponsorship goals.

5. The method of claim 4, further comprising automatically generating and electronically sending a recommendation for at least one action to achieve an established sponsorship goal.

6. The method of claim 1, wherein a system user submits data regarding the desired objectives of a sponsor to create a sponsor objectives plan.

7. The method of claim 6, further comprising:
automatically matching sponsors with community organizations, subgroups thereof, or individuals based on needs of a particular community organization, subgroup, or individual, and based on objectives of a particular sponsor, the automatic matching determined from stored information regarding a sponsorship needs plan and the sponsor objectives plan; and
automatically notifying the community organization, subgroup, or individual, and the sponsor of the automatic matching.

8. The method of claim 1, further comprising tracking and monitoring one or more customer loyalty programs linked to a sponsor, and tracking expenditures under the one or more customer loyalty programs.

9. The method of claim 1, further comprising creating a sponsorship profile in which multiple sponsorship offer plans can be run simultaneously.

10. The method of claim 1, further comprising automatically sending an electronic communication with information regarding the acceptance of a sponsorship proposal by one of the one or more individuals or community organizations or a subgroup within that community organization, or by the sponsor.

11. The method of claim 1, wherein tracking an extent of participation in the sponsorship offer plan by the participant comprises tracking purchases from the sponsor made by the participant under the sponsorship offer plan.

12. The method of claim 1, wherein allocating proceeds to the one or more community organizations or individuals based on the extent of participation in the sponsorship offer plan by the participant comprises allocating a percentage of each purchase or a fixed amount per purchase, or awarding a number of points, wherein each point has a monetary value, per purchase made by the participant under the sponsorship offer plan.

13. The method of claim 1, further comprising providing a means to electronically send a request to participate in a specific sponsorship initiative to potential sponsors.

14. The method of claim 1, further comprising creating a sponsorship proposal exchange configured to electronically receive and transmit one or more sponsorship offer plans between community organizations or individuals, sponsors, and participants.

15. The method of claim 14, further comprising configuring the sponsorship proposal exchange to electronically receive and transmit an acceptance of terms in one of the one or more sponsorship offer plans.

16. The method of claim 1, further comprising generating a profile that include past purchasing behavior for a participant so that the participant may be targeted with specific sponsorship offer plans.

17. The method of claim 1, wherein allocating proceeds to the one or more community organizations or individuals based on the extent of participation in the sponsorship offer plan by the participant comprises allocating a fixed or variable percentage of each purchase, a fixed or variable amount per purchase, or a fixed or variable number of points awarded per purchase, made by the participant under the sponsorship offer plan.

18. The method of claim 17, wherein allocating a fixed or variable percentage of each purchase, or a fixed or variable number of points awarded per purchase, made by the participant under the sponsorship offer plan comprises fixing or varying an allocation percentage of each purchase, fixing or varying an amount per purchase, or fixing or varying a number of points awarded per purchase, based on the requirements of the sponsorship offer plan.

19. The method of claim 18, wherein the sponsorship offer plan varies the allocation percentage, amount per purchase, or number of points awarded per purchase based on at least one of the time of day the purchase is made, the day of the week the purchase is made, and the month of the year the purchase is made.

20. The method of claim 18, wherein the sponsorship offer plan varies the allocation percentage, amount per purchase, or number of points awarded per purchase based on the level of participation in the sponsorship offer plan.

21. The method of claim 18, wherein the sponsorship offer plan varies the allocation percentage, amount per purchase, or number of points awarded per purchase based on past purchasing behavior.

22. The method of claim 18, wherein the sponsorship offer plan varies the allocation percentage, amount per purchase, or number of points awarded per purchase based on a specific product or service purchased by the participant.

23. The method of claim 1, further comprising automatically tracking when a sponsorship or transaction activity reaches a predetermined threshold amount, thereby generating an entry into a database to position an advertisement for a sponsor in a media network.

24. The method of claim 1, further comprising integrating the digital exchange system with a digital media network that contains digital media publications, configured to provide electronic magazines, websites, and mobile applications, whereby participants are provided subscriptions or subscribe to such digital media publications, or pre-subscribe to potential digital media publications, where the subscriptions are linked to the digital exchange system.

25. The method of claim 24, wherein linking subscriptions to the digital exchange system comprises automatically generating media content to be published on the digital media network using information gathered from the digital exchange system.

26. The method of claim 24, further comprising automatically tracking and monitoring a number of subscriptions and an amount of allocated proceeds generated through the digital exchange system by participants who subscribe to the digital media network, in order to determine an extent of production for the publications in the digital media network.

27. The method of claim 24, further comprising automatically alerting subscribers, and automatically requesting and tracking user-generated media content submittals from participants for use in one or more of the digital media publications in the digital media network.

28. The method of claim 24, further comprising disseminating information regarding the sponsorship offer plan via the digital media network.

29. The method of claim 28, wherein disseminating information regarding the sponsorship offer plan via the digital media network comprises automatically generating promotions or advertisements for placement into digital media content available via the digital media network.

30. The method of claim 1, further comprising:
receiving information from a point-of-sale (POS) system or mobile application employed by the sponsor; and
allocating funds to the one or more community organizations or individuals and, when specified, allocating funds to specific activities or subgroups or programs within the one or more community organizations based on information received from the POS system or mobile application.

31. The method of claim 30, wherein allocating funds to community organizations or individuals based on the information received from the POS system or mobile application employed by the sponsor comprises allocating funds to the one or more community organizations or individuals and to particular programs within those one or more community organizations without additional input from the participant.

32. The method of claim 31, wherein allocating funds to community organizations or individuals without any additional input from the participant comprises allocating funds to community organizations or individuals or to various specified programs and needs within those community organizations based on previously-made selections by the participant.

33. The method of claim 30, wherein receiving information from a point-of-sale (POS) system or mobile application employed by the sponsor comprises electronically receiving information from a point-of-sale (POS) system or mobile application employed by the sponsor that is scanned, automatically or electronically entered, or manually input to the point-of-sale POS system or mobile application employed by the sponsor.

34. The method of claim 33, wherein electronically receiving information from the point-of-sale (POS) system or mobile application employed by the sponsor comprises receiving participant identification and purchase information from the point-of-sale (POS) system or mobile application employed by the sponsor.

35. The method of claim 1, configuring the digital exchange system such that any of the one or more community organizations or individuals can specify a plurality of needs such that each of the plurality of needs may be linked with a different sponsorship offer plan.

36. The method of claim 35, wherein the participant can choose to be associated with any sponsorship offer plan or with any of the plurality of needs.

37. The method of claim 36, wherein the association between the participant and the sponsorship offer plan is provided via an identification code for the participant.

38. The method of claim 1, further comprising generating a unique user identification code for the participant.

39. The method of claim 1, further comprising automatically notifying the participants of any transactions completed by the participant under the sponsorship offer plan.
